(19) United States
(12) Patent Application Publication
(10) Pub. No.: US 2011/0200714 A1
(43) Pub. Date: Aug. 18, 2011

(54) COATED CONFECTIONERY PRODUCT

(76) Inventors: Sylvie Lagache, Singapore (SG); Patrice Demeulemeester, Linselles (FR); Nathalie Montaigne, Marcq En Baroeul (FR)

(21) Appl. No.: 12/865,141

(22) PCT Filed: Jan. 23, 2009
(86) PCT No.: PCT/GB09/00198

§ 371 Date: Mar. 17, 2011

(30) Foreign Application Priority Data
Jan. 30, 2008 (GB) 0801676.8

(51) Int. Cl. A23G 3/54; A23G 3/42

(52) U.S. Cl. 426/103; 426/292

(57) ABSTRACT

In one aspect, the invention relates to a process for the preparation of a starch-coated confectionery product. The process comprises providing a centre, wetting the centre, coating the wetted centre with a starch-based powder, and expanding the starch-based powder to produce the starch-coated confectionery product. Other aspects of the invention relate to a confectionery product comprising a centre (such as peanut) and an expanded starch coating producible by the process of the first aspect and a confectionery product comprising a heat-sensitive centre (such as chocolate) enclosed successively within a protective coating and an expanded starch coating.

The present, invention relates to a coated confectionery product and a process for making a coated confectionery product.

It is known to prepare chocolate-coated confectionery products, for example, by enrobing or panning centres such as nuts, dried fruit, or toffee. It is also known to prepare sugar-shelled confectionery products such as sugared almonds and Mini-eggs® (Cadbury Limited) by sugar panning a centre. There is a desire for new types of coated confectionery products, especially for those that offer different textures, flavours and mouthfeel.

The object of the present invention is to provide a new type of confectionery product based on a confectionery centre and an expanded starch coating, and a process for making such a confectionery product.

According to a first aspect of the present invention there is provided a process for the preparation of a starch-coated confectionery product comprising the following steps:
(i) providing a centre;
(ii) wetting the centre;
(iii) coating the wetted centre with a starch-based powder; and
(iv) expanding the starch-based powder to produce the starch-coated confectionery product.

According to a second aspect of the present invention there is provided a confectionery product comprising a centre and an expanded starch coating producible by the process of the first aspect.

According to a third aspect of the present invention there is provided a confectionery product comprising a heat-sensitive centre enclosed successively within a protective coating and an expanded starch coating.

In step (ii) wetting is carried out such that the starch-based powder will adhere to the centre when step (iii) is carried out. The centre is substantially coated with a wetting solution in order to wet it.

Step (ii) followed by step (iii) results in the formation of one layer of coating. Steps (ii) and (iii) may be repeated as desired in order to build up layers of coating prior to carrying out expansion step (iv).

In one embodiment, steps (ii) and (iii) are repeated at least three times in order to build up at least three layers of coating prior to carrying out expansion step (iv). In a series of embodiments, steps (ii) and (iii) are repeated at least five times, at least seven times, at least ten times or at least fifteen times in order to build up at least five, at least seven, at least ten or at least fifteen layers of coating respectively. In a particular embodiment, steps (ii) and (iii) are repeated ten times in order to build up ten layers of coating.

When more than one layer of coating is applied to the centre, the composition of the wetting solution in each step (ii) and/or the starch-based powder in each step (iii) may be varied for some or all of the layers or the same wetting solution and starch-based powder may be used throughout.

The first starch-based powder (for the first layer) may be different from or the same as the second starch-based powder (for the second layer) and the same as or different from subsequent starch-based powders (for subsequent layers) and the same as or different from the final starch-based powder (for the outermost layer).

Steps (ii) and (iii) may, for example, be carried out by enrobing or panting the centres. Conveniently, the process of steps (ii) and (iii) are carried out by panning the centre in a panning drum.

The centre may be heated whilst steps (ii) and (iii) are being carried out.

The starch-based powder may be expanded by heating the coated centre to the required expansion temperature. The method of heating will depend on the required temperature, but heating will in general be carried out in an oven or in oil. Suitable heating temperatures are about the conventional temperatures for expanding starch materials. In the case of heating in an oven (baking), temperatures are likely to be from 175° C. to 250° C. For frying in oil, temperatures are likely to be about 160° C.

If desired, the process may comprise an additional step after step (iv) in which the starch-coated confectionery product is coated with a confectionery coating. For example, the starch-coated confectionery product may be enrobed with a chocolate composition.

The centre may comprise any foodstuff. For example, the centre may comprise fruit, nuts, chocolate, or confectionery. Suitable fruits include fresh fruit and dried fruits such as dried apricots, sultanas, raisins, currants, and banana chips. Suitable nuts include almonds, Brazil nuts, cashews, hazelnuts, peanuts and pistachios. Suitable chocolate centres include dark chocolate, milk chocolate and white chocolate. Suitable confectionery centres include toffee, caramel, nougat, and marshmallow, as well as ready-made confectionery products such as M&Ms®, Bonibon®, Smarties®, or Mini Eggs®.

The wetting solution comprises an edible material in water. The wetting solution may in one series of embodiments have a dry solids (D.S.) content of from 20 to 80 wt %, from 33 to 66 wt % or from 45 to 55 wt %. For example, the wetting solution may have a dry solids content of about 50 wt %.

The wetting solution may comprise a sweetener and/or a hydrocolloid (both edible materials) since these have adhesive properties. Suitable sweeteners include sugars (e.g. sucrose, dextrose, glucose, fructose, lactose, trehalose and maltose and any combination thereof including honey), sugar-substitutes or combinations thereof. Suitable sugar substitutes include sugar alcohols (e.g. sorbitol, xylitol, mannitol, lactitol, isomalt, maltitol and in a particular embodiment sorbitol and/or xylitol), and intense sweeteners (e.g. aspartame, acesulfame-K, cyclamates, saccharin, sucralose, neohesperidin, dihydrochalone, alitame, stena sweeteners, glycyrrhizin and in a particular embodiment sucralose and/or acesulfame-K). Suitable hydrocolloids include gum arabic, gelatin, carageenan, agar and pectin. In one embodiment, the wetting solution comprises sucrose and/or glucose.

Starch is a mixture of two complex carbohydrates, amylose (a linear polymer of glucose) and amylopectin (a highly branched polymer of glucose). Starches with high amylopectin content are associated with high expansion properties. Some starches, such as waxy maize flour and cassava flour, have a naturally high amylopectin content and are highly expandable. Modified starches may also have a high amylopectin content and may be highly expandable. For example, pregelatinized starches such as pregelatinized waxy maize flour and pregelatinized sticky rice flour, have high amylopectin contents and expand more on baking than most native (unmodified) starches.

In one embodiment, the starch-based powder comprises a starch that has a high amylopectin content i.e. an amylopectin to amylose ratio of at least 85:15, or at least 90:10 or at least 95:5. The starch-based powder may also comprise a relatively low amylopectin content starch (i.e. a starch having an amylopectin to amylose ratio of less than 85:15). In a further embodiment, the starch-based powder comprises both a high amylopectin content starch and a relatively low amylopectin content starch.

The starch-based powder may comprise a starch derived from wheat, maize (corn), potato, rice, arracacha, buckwheat, banana, barley, cassava, kudzu, peas, oca, sago, sorghum, sweet potato, taro and yams, or any combination thereof. In one embodiment, the starch-based powder comprises a wheat starch, a maize (corn) starch, a potato starch, a rice starch or any combination thereof.

Suitable modified starches include pre-gelatinized starches such as pre-gelatinized waxy maize flour and pre-gelatinized sticky rice flour.

When the starch-based powder comprises both a high amylopectin content starch and a relatively low amylopectin content starch, the ratio of high amylopectin content starch to relatively low amylopectin starch may be in one embodiment from 10:90 to 90:10, in another embodiment from 25:75 to 75:25, in a further embodiment from 33:67 to 33:67, in a yet further embodiment from 40:60 to 60:40 and a yet further embodiment 50:50. In a particular embodiment, the ratio of high amylopectin content starch to relatively low amylopectin starch is around 50:50.

It will be understood that the relatively low amylopectin content starch will be less expandable than the high amylopectin content starch and by controlling the ratio of the two starches in the starch-based powder the overall extent of the expansion of the starch-based powder may be controlled.

When the centre is a heat sensitive centre such as chocolate, one or more protective coatings may be provided around the heat sensitive centre. Thus the process may comprise an additional step prior to the first coating with starch-based powder of providing the centre with a protective coating. Hereto, we have found that starch-based powders that do not expand or expand very little are suitable for protecting the heat-sensitive centre. In one embodiment, the protective coating is a relatively low amylopectin content starch. Suitable starch-based powders include native starches such as wheat starch or potato starch. In the case where a protective coating is provided it may be necessary to wet the centre prior to applying the protective coating (for example, where a relatively low amylopectin content starch is used as the protective coating). It will be understood that reference to wetting the centre in step (ii) is to wetting the protective coating in the case where such a coating is provided.

In one embodiment, an additional step is carried out prior to the expansion of the starch-based powder in which the starch-coated centre is provided with a less expandable outer coat of starch-based powder. The underlying starch layer or layers will expand more than the outermost less expanding starch layer thereby causing an attractive cracking effect in the outermost layer. In a further embodiment, the outer coat of less expandable starch-based powder comprises a native starch. In one series of further embodiments, the outer coat of less expandable starch-based powder comprises at least 70 wt %, at least 80 wt %, or at least 90 wt % native starch.

The starch-based powder may comprise further ingredients in addition to starch. In one embodiment, the starch-based powder may comprise at least one sweetener, at least one flavour ingredient, at least one dietary fibre, at least one protein (e.g. gluten), at least one food colouring, at last one leavening agent (e.g. baking powder), at least one vitamin or mineral supplement or any combination thereof.

Suitable sweeteners include sugars (e.g. sucrose, dextrose, glucose syrup solids, fructose, lactose, trehalose and maltose and any combination thereof), sugar alcohols (e.g. sorbitol, xylitol, mannitol, lactitol, isomalt, maltitol, or any combination thereof), intense sweeteners (e.g. aspartame, acesulfame-K, cyclamates, saccharin, sucralose, neohesperidin, dihydrochalone, alitame, stena sweeteners, glycyrrhizin, or any combination thereof) and any combination of sugars, sugar alcohols and intense sweeteners.

Suitable flavour ingredients include those in solid form, for example, a powder. Suitable flavour ingredients include cocoa powder and spray dried flavoured powders such as spray dried fruit powder. In a further embodiment, the flavour ingredient is encapsulated in order to protect it from degradation on heating. For example, spray dried fruit powders are often encapsulated by spray drying fruit juice onto a maltodextrin base.

In a further embodiment one or more food colourings may be employed in different layers in order to emphasise the layered structure of the confectionery product.

Embodiments of the invention will now be described by way of example only.

### Methodology

A panning drum (capacity of 0.5 to 2 kg) was rotated at approximately 200 rpm and heated to approximately 30° C. by applying a hair dryer to the outside of the drum. The confectionery centres were weighed and then added to the panning drum. Sufficient wetting solution was added to the confectionery centres in the panning drum to just cover (wet) the surfaces of the centres (approximately 0.3 g wetting solution per gram of confectionery centres). Powdered starch mix was then added to the wetted centres until all of the centres were lightly coated with the starch mix (approximately 1.3 g starch mix per gram of wetting solution). Once the confectionery centres had one layer of wetting solution/starch mix coating, the process was repeated to build up additional layers. It will be appreciated that excess wetting solution and starch mix must be employed because some of the wetting solution and starch mix will adhere to the panning drum. On average each confectionery centre was coated with 10 layers of wetting solution/starch mix such that the weight ratio of centre to shell (wetting solution and starch mix) was from 20-25% centre to 75-80% shell. The coated confectionery centres were then transferred to an oven and baked for 10 to 15 minutes at 200° C.

All percentages are by weight.

### Ingredients

| | |
|---|---|
| Confectionery | Dried, diced apricot |
| centres | Peanut |
| | Bonibon ® (a sugar shelled chocolate product made by |
| | Cadbury Schweppes) Chocolate (Barry Callebaut) |
| Wetting | 50% D.S. (dry solids) sucrose solution |
| solutions | 50% D.S. (dry solids) glucose solution |
| Starch mix | Standard wheat flour |
| ingredients | Modified starch (sold under the trade name |
| | Pregeflo ® CH10G, by Roquette Frères) - a pre- |
| | gelatinized modified waxy maize starch |
| | Sucrose (sold under the trade name Silk Sugar ®, by |
| | British Sugar) - a fine sugar having an average particle |
| | size of 9 microns (9 μm) |
| | Banana flavour (spray dried on maltodextrin base, |
| | Symrise) Orange flavour |

### EXAMPLES 1 TO 3

| | Ex. 1 | Ex. 2 | Ex. 3 |
|---|---|---|---|
| Confectionery centre | Dried diced | Peanut | Chocolate |
| Wetting solution | apricot 50% | 50% D.S. | 50% D.S. |
| | D.S. sucrose | sucrose | sucrose |
| | solution | solution | solution |
| Starch mix | 40% standard | 40% standard | 40% standard |
| | wheat flour | wheat flour | wheat flour |
| | 40% modified | 40% modified | 40% modified |
| | starch | starch | starch |
| | 20% sucrose | 20% sucrose | 20% sucrose |
| Density (g/cm³) | 0.35 | Not available | Not available |
| Weight ratio | 24/76 | Not available | Not available |
| of centre/shell | | | |
| before expansion | | | |

The apricot and peanut products (Ex. 1 and Ex. 2) are successful. The coating expands to provide an attractive baked product. The chocolate centre (Ex. 3) is heat sensitive and leaked out of the coating when heated in the oven at 200° C.

### EXAMPLE 4

| | Ex. 4 | Ex. 5 |
|---|---|---|
| Confectionery | Chocolate | Chocolate |
| centre | | |
| Wetting solution | 50% D.S. sucrose | 50% D.S. sucrose |
| | solution | solution |
| Protective coating | 100% standard | 100% standard |
| | wheat flour | wheat flour |
| Starch mix | 40% standard wheat | 40% standard wheat |
| | flour | flour |
| | 40% modified starch | 40% modified starch |
| | 20% sucrose | 20% sucrose |

In response to the problem of leakage of chocolate shown in Ex. 3 an improved process was developed for heat-sensitive centres. The heat sensitive centre was first wetted with sucrose solution followed by a protective coating comprising 100% wheat starch before additional coatings with the starch mix of examples 1 to 3. Wheat starch has a high amylose level as compared to modified starch and does not expand as much as the starch mix that contains both wheat starch and modified starch. In Ex. 4 the chocolate centre was coated with two layers of the protective coating followed by eight layers of the starch mix. In Ex. 5 the chocolate centre was coated with one layer of the protective coating followed by nine layers of the starch mix. Neither Ex. 4 nor Ex. 5 leaked when heated in the oven. This suggests that a high amylose level starch mix protects the centre from the heat of the oven. The coating around the chocolate centre was harder in Ex. 4 than in Ex. 5. Depending on consumer tastes, it may be desirable to have fewer layers of the protective coating whilst maintaining a sufficient barrier to prevent leakage.

### EXAMPLES 6 AND 7

| | Ex. 6 | Ex. 7 |
|---|---|---|
| Confectionery | Bonibon ® | Bonibon ® |
| centre | | |
| Wetting solution | 50% D.S. sucrose | 50% D.S. sucrose |
| | solution | solution |
| Starch mix | 68% standard wheat flour | 50% standard wheat flour |
| | 32% modified starch | 50% modified starch |

Confectionery products were prepared using a starch mix comprising wheat flour and modified starch. The ratio of wheat flour to modified starch affected the expansion of the coating. Ex. 7 contains more modified starch than Ex. 6 and had greater and more homogeneous expansion than Ex. 6. Ex. 7 therefore has a lower density than Ex. 6.

### EXAMPLES 8 TO 10

| | Ex. 8 | Ex. 9 | Ex. 10 |
|---|---|---|---|
| Confectionery | Bonibon ® | Bonibon ® | Bonibon ® |
| centre | | | |
| Wetting solution | 50% D.S. | 50% D.S. | 50% D.S. |
| | sucrose | sucrose | sucrose |
| | solution | solution | solution |
| Starch mix | 20% sucrose | 19.6% sucrose | 19.4% sucrose |
| | 80% modified | 39.2% modified | 38.8% modified |
| | starch | starch | starch |
| | | 39.2% standard | 38.8% standard |
| | | wheat flour | wheat flour |
| | | 2.0% banana | 2.9% orange |
| | | flavour | flavour |
| Cracking Effect | n/a | n/a | Standard wheat |
| | | | flour |
| Enrobing | n/a | Dark compound | n/a |
| | | coating | |
| Density (g/cm³) | 0.19 | 0.38 | 0.33 |
| Weight ratio of | 24/76 | 20/80 | 16/84 |
| centre/shell | | | |
| before expansion | | | |
| Change in weight | −24% | −21% | −23% |
| ratio after | | | |
| expansion | | | |

Ex. 8 expanded even more than Ex. 7 but the expansion was not homogeneous. A gap formed around the confectionery centre providing an interesting hollow effect. Ex. 8 had a density of just 0.19 g/cm³.

Ex. 9 was additionally enrobed with a dark compound coating. Ex. 10 was coated with an outer coat of standard wheat flour prior to expansion. The outer coat of standard wheat flour did not expand as much as the underlying layers that comprised modified starch thereby resulting in an attractive cracked effect in the final product.

1. A process for the preparation of a starch-coated confectionery product comprising:
providing a heat-sensitive centre;
wetting the heat-sensitive centre;
coating the wetted heat-sensitive centre with a starch-based powder; and
expanding the starch-based powder to produce the starch-coated confectionery product;
wherein the heat-sensitive centre is coated with a protective coating prior to the first coating with the starch-based powder and the protective coating consists of one or more starch-based powders that have no or very little expansion.

2. The process according to claim 1, wherein the wetting and the coating are repeated at least three times in order to build up at least three layers of coating prior to the expansion.

3. The process according to claim 1, wherein the wetting and the coating are carried out by panning the heat-sensitive centre.

4. The process according to claim 1, wherein the starch-based powder is expanded by heating the coated heat-sensitive centre to a required expansion temperature.

5. The process according to claim 1, wherein the starch-coated confectionery product is coated with a confectionery coating after the expansion.

6. The process according to claim 1, wherein the heat-sensitive centre comprises one or more of fruit, nuts, chocolate, or confectionery.

7. The process according to claim 1, wherein the wetting is carried out by substantially coating the heat-sensitive centre with a wetting solution comprising a sweetener and/or a hydrocolloid.

8. The process according to claim 1, wherein the starch-based powder comprises a starch having an amylopectin to amylose ratio of at least 85:15.

9. The process according to claim 8, wherein the starch having an amylopectin to amylose ratio of at least 85:15 is a pre-gelatinized starch such as pre-gelatinized waxy maize flour or pre-gelatinized sticky rice flour.

10-11. (canceled)

12. The process according to claim 1, wherein the wetted and coated heat-sensitive centre is provided with an outer coat of a starch-based powder prior to the expansion, said outer coat being less expandable than the starch-based coating to which it is applied.

13. A confectionery product comprising a heat-sensitive centre and an expanded starch coating producible by the process of claim 1.

14. A starch-coated confectionery product comprising a heat-sensitive centre enclosed successively within a protective coating and an expanded starch coating; wherein the protective coating consists of one or more starch-based powders that do not expand or expand very little.

15. The process of claim 1 wherein the protective coating is a low amylopectin starch.

16. The process of claim 15, wherein the low amylopectin starch is a native starch.

17. The process of claim 16, wherein the native starch is a wheat starch or a potato starch.

18. The confectionery product of claim 13 wherein the protective coating is a low amylopectin starch.

19. The confectionery product of claim 18, wherein the low amylopectin starch is a native starch.

20. The confectionery product of claim 19, wherein the native starch is a wheat starch or a potato starch.

21. The starch-coated confectionery product of claim 14 wherein the protective coating is a low amylopectin starch.

22. The starch-coated confectionery product of claim 21, wherein the low amylopectin starch is a native starch.

23. The starch-coated confectionery product of claim 22, wherein the native starch is a wheat starch or a potato starch.
